(19) United States
(12) Patent Application Publication
(10) Pub. No.: US 2019/0102810 A1
(43) Pub. Date: Apr. 4, 2019

(54) METHODS AND SYSTEMS FOR CALCULATING AIRCRAFT COMPONENT VALUE

(71) Applicant: The Boeing Company, Chicago, IL (US)

(72) Inventors: Joseph F. Floyd, Chicago, IL (US); Brent L. Hadley, Chicago, IL (US); Patrick J. Eames, Chicago, IL (US); Robert J. Martin, Chicago, IL (US); Terry Davidson, Chicago, IL (US)

(21) Appl. No.: 15/722,610

(22) Filed: Oct. 2, 2017

(51) Int. Cl. G06Q 30/02

(52) U.S. Cl. CPC G06Q 30/0283

(57) ABSTRACT

Example computing systems perform functions for calculating a sum representing a value of a system component or a structural component of an aircraft. The functions may include identifying the component for analysis and assigning numerical ratings that pertain to how the component relates to respective criteria. The criteria may include one or more of whether the component is described in an illustrated parts catalog, a reorder lead time, a component class, a price, whether repairing or replacing the component requires taking an aircraft out of service, a quantity of repair authorizations that have been issued for the component, or a quantity of communications regarding the component. The functions may further include calculating a sum of the assigned ratings and, based on determining that the sum exceeds (or is less than) a threshold value, initiating (or ceasing) a process to retrieve or curate one or more instances of the component.

### FIELD

The present disclosure generally relates to computing systems and data structures, and more specifically to computing systems and data structures configured to perform functions for calculating a sum representing a value of an aircraft component.

### BACKGROUND

At times, various system components and/or structural components of aircraft fail or malfunction. Some such components may be repaired in place on the aircraft or while the component is temporarily removed from the aircraft. Other components may be replaced with new components purchased from a manufacturer or used components that are removed from retired aircraft.

Replacing components with used replacements, however, is often not as simple as finding a retired aircraft that is of the same model group as the aircraft in need of the replacement component and removing the desired replacement component from the retired aircraft. For example, the part number of a component (e.g., a lighting panel) that is installed in a particular model of aircraft at the point of manufacture may change over the production lifetime of that aircraft. Upon receiving a customer's request for a used component, a salvager may first locate an aircraft that could potentially have the desired component onboard the retired aircraft, search for the component on the aircraft, remove the component, and determine the component's part number via visual inspection before knowing whether the salvager has possession of the component desired by the customer. Thus, time and effort may be wasted in cases where the salvager does not find the desired component even though there was reason to believe that the desired component might be onboard the retired aircraft. For this and other reasons, it may be inefficient for the salvager to personally search retired aircraft for components requested by customers on an ad hoc basis.

The benefit from ongoing efforts to retrieve and/or curate a particular component from retired aircraft may be affected by many factors that can be quantized in data structures. However, it may take undesirably long amounts of time to search conventional data structures in response to a search request and/or to update the data structures in response to receipt of new information.

Accordingly, there is a need for systems, methods, and data structures that utilize many types of data to determine the value of various aircraft components and/or to determine whether to spend resources retrieving aircraft components from retired aircraft and curating them.

### SUMMARY

One aspect of the disclosure is a computing system configured to perform functions for calculating a sum representing a value of an aircraft system component. The computing system includes one or more processors and one or more non-transitory computer readable media. The one or more non-transitory computer readable media store data pertaining to (i) whether a component is described in an illustrated parts catalog, (ii) a reorder lead time for the component, (iii) a component class to which the component belongs, where the component class pertains to how difficult the component is to repair, (iv) a price of the component, and (v) whether repairing or replacing the component requires taking an aircraft out of service. The one or more non-transitory computer readable media also store instructions, that when executed by the one or more processors, cause the computing system to perform functions. The functions include identifying the component for analysis and determining (i) whether the component is described in the illustrated parts catalog, (ii) the reorder lead time for the component, (iii) the component class to which the component belongs, (iv) the price of the component or that the price is unavailable, and (v) whether repairing or replacing the component requires taking an aircraft out of service. The functions further include, based on results of the determining and predefined relationships between potential results of the determining and numerical values, assigning numerical ratings respectively pertaining to (i) whether the component is described in the illustrated parts catalog, (ii) the reorder lead time for the component, (iii) the component class to which the component belongs, (iv) the price of the component, and (v) whether repairing or replacing the component requires taking an aircraft out of service. The functions further include calculating a sum of the assigned ratings and, based on determining that the sum exceeds a threshold value, initiating a process to retrieve or curate one or more instances of the component.

Another aspect of the disclosure is a computing system configured to perform functions for calculating a sum representing a value of an aircraft structural component. The computing system includes one or more processors and one or more non-transitory computer readable media. The one or more non-transitory computer readable media store data pertaining to (i) a quantity of repair authorizations that have been issued for a component, (ii) a quantity of communications between a supplier and a customer, where the communications regard repair authorizations issued for the component, (iii) a reorder lead time for the component, (iv) a quantity of communications between representatives of the supplier regarding repair authorizations issued for the component, and (v) a price of the component. The one or more non-transitory computer readable media also store instructions, that when executed by the one or more processors, cause the computing system to perform functions. The functions include identifying the component for analysis and determining (i) the quantity of repair authorizations that have been issued for the component, (ii) the quantity of communications between the supplier and a customer, (iii) the reorder lead time for the component, (iv) the quantity of communications between representatives of the supplier regarding repair authorizations issued for the component, and (v) the price of the component or that the price is unavailable. The functions further include, based on results of the determining and predefined relationships between potential results of the determining and numerical values, assigning numerical ratings respectively pertaining to (i) the quantity of repair authorizations that have been issued for the component, (ii) the quantity of communications between the supplier and a customer, (iii) the reorder lead time for the component, (iv) the quantity of communications between representatives of the supplier regarding repair authorizations issued for the component, and (v) the price of the component. The functions further include calculating a sum of the assigned ratings and, based on determining that the sum exceeds a threshold value, initiating a process to retrieve or curate one or more instances of the component.

Yet another aspect of the disclosure is a computing system configured to perform functions for calculating a sum representing a value of an aircraft system component. The computing system includes one or more processors and one or more non-transitory computer readable media. The one or more non-transitory computer readable media store data pertaining to (i) whether a component is described in an illustrated parts catalog, (ii) a reorder lead time for the component, (iii) a component class to which the component belongs, where the component class pertains to how difficult the component is to repair, (iv) a price of the component, and (v) whether repairing or replacing the component requires taking an aircraft out of service. The one or more non-transitory computer readable media also store instructions, that when executed by the one or more processors, cause the computing system to perform functions. The functions include identifying the component for analysis and determining (i) whether the component is described in the illustrated parts catalog, (ii) the reorder lead time for the component, (iii) the component class to which the component belongs, (iv) the price of the component or that the price is unavailable, and (v) whether repairing or replacing the component requires taking an aircraft out of service. The functions further include, based on results of the determining and predefined relationships between potential results of the determining and numerical values, assigning numerical ratings respectively pertaining to (i) whether the component is described in the illustrated parts catalog, (ii) the reorder lead time for the component, (iii) the component class to which the component belongs, (iv) the price of the component, and (v) whether repairing or replacing the component requires taking an aircraft out of service. The functions further include calculating a sum of the assigned ratings and, based on determining that the sum is less than a threshold value, initiating a process to cease retrieving or curating instances of the component.

The features, functions, and advantages that have been discussed can be achieved independently in various embodiments or may be combined in yet other embodiments further details of which can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of an illustrative embodiment of the present disclosure when read in conjunction with the accompanying Figures.

FIG. 1 is a schematic diagram of a computing system, according to an example embodiment.

FIG. 2 illustrates data regarding aircraft components, according to an example embodiment.

FIG. 3 illustrates data regarding aircraft components, according to an example embodiment.

FIG. 4 illustrates data regarding aircraft components, according to an example embodiment.

FIG. 5 illustrates data regarding aircraft components, according to an example embodiment.

FIG. 6 is a block diagram of a method, according to an example embodiment.

FIG. 7 is a block diagram of a method, according to an example embodiment.

FIG. 8 is a block diagram of a method, according to an example embodiment.

FIG. 9 is a block diagram of a method, according to an example embodiment.

FIG. 10 is a block diagram of a method, according to an example embodiment.

### DETAILED DESCRIPTION

As discussed above, there exists a need for systems, methods, and data structures that utilize many types of data to determine the value of various aircraft components and/or to determine whether to expend resources retrieving aircraft components from retired aircraft and curating them. Accordingly, such apparatus and methods are disclosed herein.

For example, a computing system may be configured to access data related to various factors that can be used to determine the value of various aircraft components, or more specifically, the value of retrieving and/or curating used components from retired aircraft. Many factors may be informative about the value of a used version of a particular aircraft component. One such factor may be whether the particular component is depicted or described in an illustrative parts catalog (IPC) that is possessed by or otherwise accessible to customers (e.g., passenger or commercial airline companies). Being included in the IPC makes it easier for the customer to identify the component needing replacement and to research replacement options. The IPC may also explain how to replace the component. As such, inclusion in the IPC will generally correlate with higher value for used replacement versions of the component.

Another such factor that is indicative of used component value may be what the reorder lead time (ROLT) is for a new version of the component. ROLT is a measure of how long it takes for a customer to receive a new version of the component upon placing an order for the component. Longer ROLT indicates some degree of scarcity and perhaps correlates positively with how willing a customer would be to purchase a used version of the component that has a lead time that is not limited by manufacturing time. Thus, increased ROLT may correlate with a higher value for the used replacement component.

Yet another such factor that is indicative of used component value may be the spare part class (SPC) to which the component belongs. Some classes of components are easier for a customer to repair than others. Others are not repairable by the customer at all. Thus, the easier a class of components is to repair, the more likely the customer is to repair the component rather than order a replacement for it. On the other hand, the harder it is for a customer to repair a component of a particular class, the more demand for replacement components of that class there will be.

Yet another such factor that is indicative of used component value may be a market price for new or used versions of the component. Such prices indicate current supply and customer demand for new or used versions of the component.

Another factor that is indicative of used component value may be whether repairing or replacing the component requires taking an aircraft out of service. Airlines may be more likely to replace a component than repair that component if replacement can be done quickly while the aircraft is waiting at the gate being refueled or boarded, for example. On the other hand, if either repairing or replacing a component (e.g., landing gear) requires taking the aircraft out of service, than there might not be any advantage to replacing the component as compared to repairing it.

Yet another factor that is indicative of used component value may be how many repair authorizations for that component have been issued (e.g., by a supplier of aircraft and aircraft components). Government regulations may require that the supplier of a component approve and/or guide efforts by airlines to repair certain aircraft components. If many repair authorizations are issued by a supplier for a particular component, that may indicate some demand for replacement components, as replacement may be easier than repair in some instances.

Yet another factor that is indicative of used component value may include a quantity of communications (e.g., emails) that exist between a supplier and a customer regarding repair authorizations issued for the component. Communications between the consumer and the supplier regarding repair of a component may indicate an amount of time and effort being spent by the consumer and/or the supplier in attempting to repair the component. Higher levels of effort being expended to repair a component may indicate that demand exists for replacement versions of the component. The quantity of internal communications that exist between employees of the supplier regarding repair authorizations issued for the component may also be indicative of ongoing difficulties in repair efforts related to the component and high value in replacing the component instead.

The effectiveness of considering one or more of the aforementioned factors and/or additional factors to determine used component value may be limited by how often the data regarding the factors and components is updated, how easily the data structure can be modified to account for new factors, and how fast the data structure can be searched. For instance, it will be advantageous to make decisions about whether to begin or cease efforts to retrieve or curate a particular component based on the most recent information. Accordingly, it may be beneficial to structure such data structures in the form of a self-referential table that will be discussed in more detail below.

Disclosed embodiments will now be described more fully hereinafter with reference to the accompanying Drawings, in which some, but not all of the disclosed embodiments are shown. Indeed, several different embodiments may be described and should not be construed as limited to the embodiments set forth herein. Rather, these embodiments are described so that this disclosure will be thorough and complete and will fully convey the scope of the disclosure to those skilled in the art.

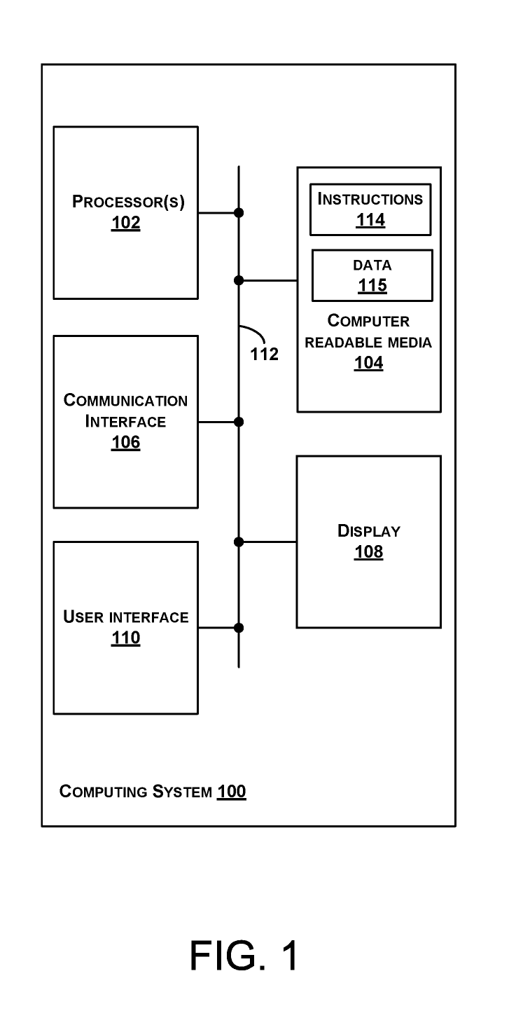

Referring now to FIG. 1, an example computing system 100 is illustrated. In some examples, components illustrated in FIG. 1 may be distributed across multiple computing devices or computing systems. However, for the sake of example, the components are shown and described as part of one example computing system 100. The computing system 100 may be or include a mobile device (such as a mobile phone), a desktop computer, a laptop computer, a tablet computer, a server, a network of multiple servers, or similar device(s) that may be configured to perform the functions described herein.

As shown in FIG. 1, the computing system 100 may include one or more processors 102, one or more non-transitory computer readable media 104, a communication interface 106, a display 108, and a user interface 110. Components illustrated in FIG. 1 may be linked together by a system bus, network, or other connection mechanism 112.

The one or more processors 102 may be any type of processor(s), such as a microprocessor, digital signal processor, multicore processor, etc., coupled to the one or more non-transitory computer readable media 104. The one or more non-transitory computer readable media 104 may be any type of memory, such as volatile memory like random access memory (RAM), dynamic random access memory (DRAM), static random access memory (SRAM), or non-volatile memory like read-only memory (ROM), flash memory, magnetic or optical disks, or compact-disc read-only memory (CD-ROM), among other devices used to store data or programs on a temporary or permanent basis.

Additionally, the one or more non-transitory computer readable media 104 may be configured to store instructions 114. The instructions 114 may be executable by the one or more processors 102 to cause the computing system 100 to perform any of the functions described herein.

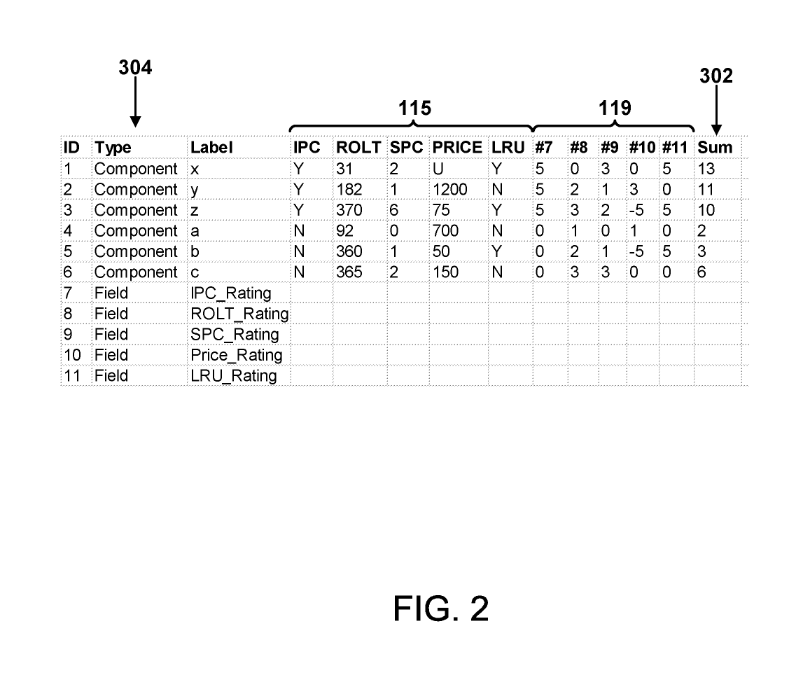

The one or more non-transitory computer readable media 104 may also be configured to store data 115. Various portions of the data 115 are shown in FIGS. 2, 3, 4, and 5.

FIG. 2 shows data arranged as a table. The data 115 depicted in FIG. 2 may pertain to (i) whether a component 304 is described in an illustrated parts catalog (IPC), (ii) a reorder lead time (ROLT) for the component 304, (iii) a component class (SPC) to which the component 304 belongs, where the component class pertains to how difficult the component 304 is to repair, (iv) a price of the component 304, and (v) whether repairing or replacing the component 304 requires taking an aircraft out of service.

Some classes of components are easier for a customer to repair than others. Others are not repairable by the customer at all. Thus, the easier a class of components is to repair, the more likely the customer is to repair the component rather than order a replacement for it. On the other hand, the harder it is for a customer to repair a component of a particular class, the more demand for replacement components of that class there will be.

The IPC is a document or collection of data that includes illustrations and/or descriptions about the component 304 and perhaps instructions about how to replace the component 304. As referred to herein, an IPC may take the form of any document or collection of data known to those of ordinary skill in the art as an “illustrated parts catalog,” or the IPC may be referred to by other (e.g., generic) names as well. ROLT is a measure (e.g., estimate) of how long it takes for a customer to receive a new version of the component 304 upon placing an order for the component 304.

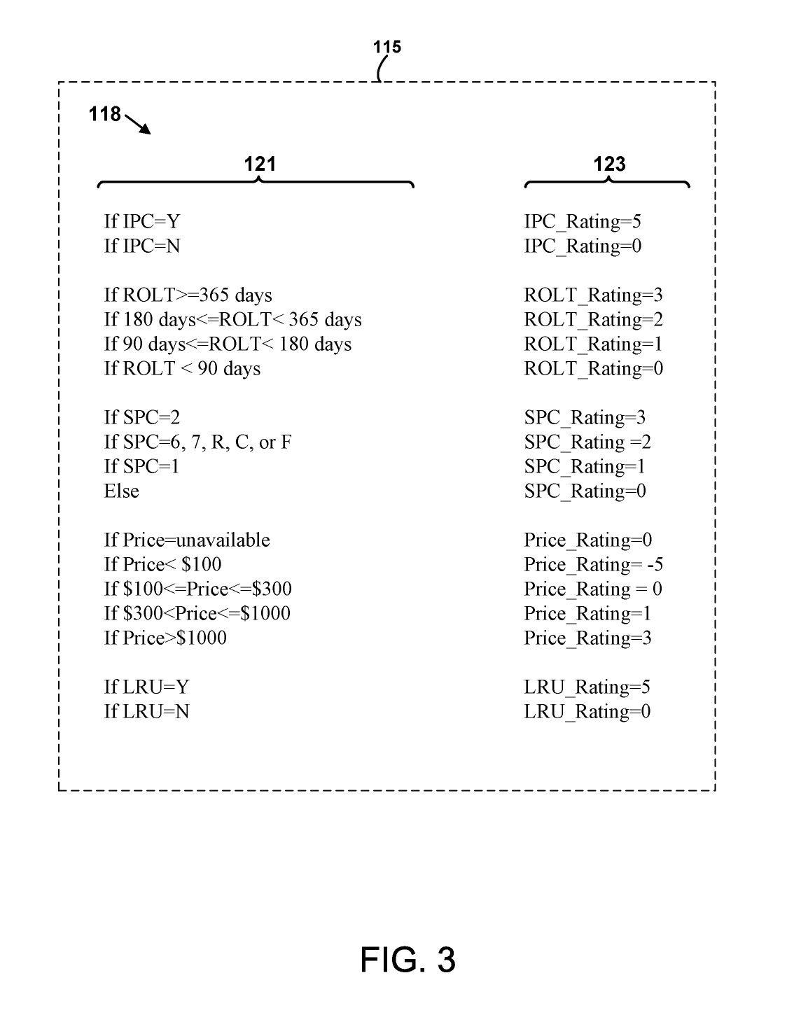

FIG. 3 shows additional data 115 arranged as a table. As shown in FIG. 3, the data 115 may also represent predefined relationships 118 between potential results 121 and numerical values 123. FIG. 3 is described in more detail below.

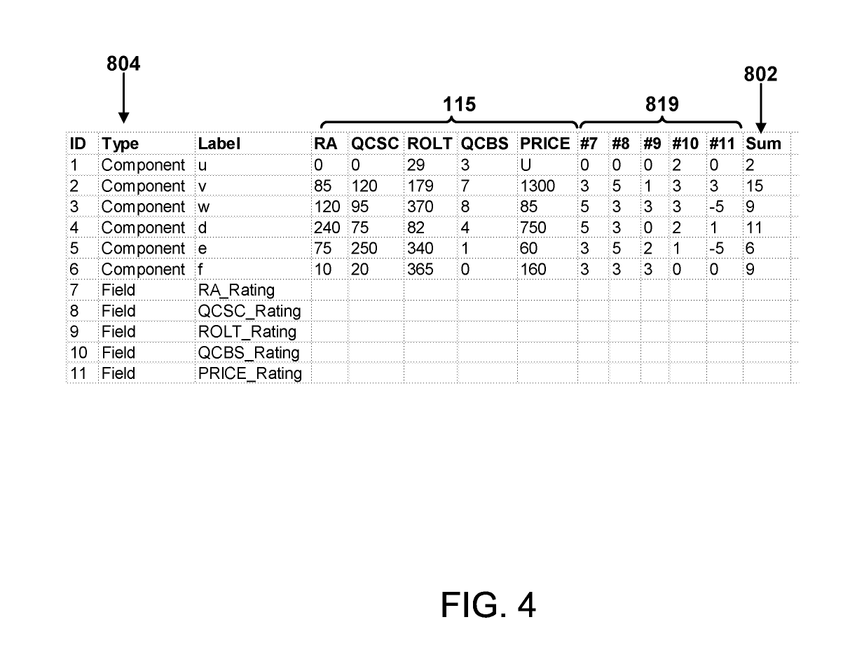

FIG. 4 shows additional data 115 arranged as a table. As shown in FIG. 4, the data 115 may also pertain to (i) a quantity of repair authorizations that have been issued (e.g., by a component supplier to an airline) for a component 804, (ii) a quantity of communications between a supplier and a customer (e.g., an airline), where the communications regard repair authorizations issued for the component 804, (iii) a reorder lead time for the component 804, (iv) a quantity of communications between representatives of the supplier regarding repair authorizations issued for the component 804, and (v) a price of the component 804.

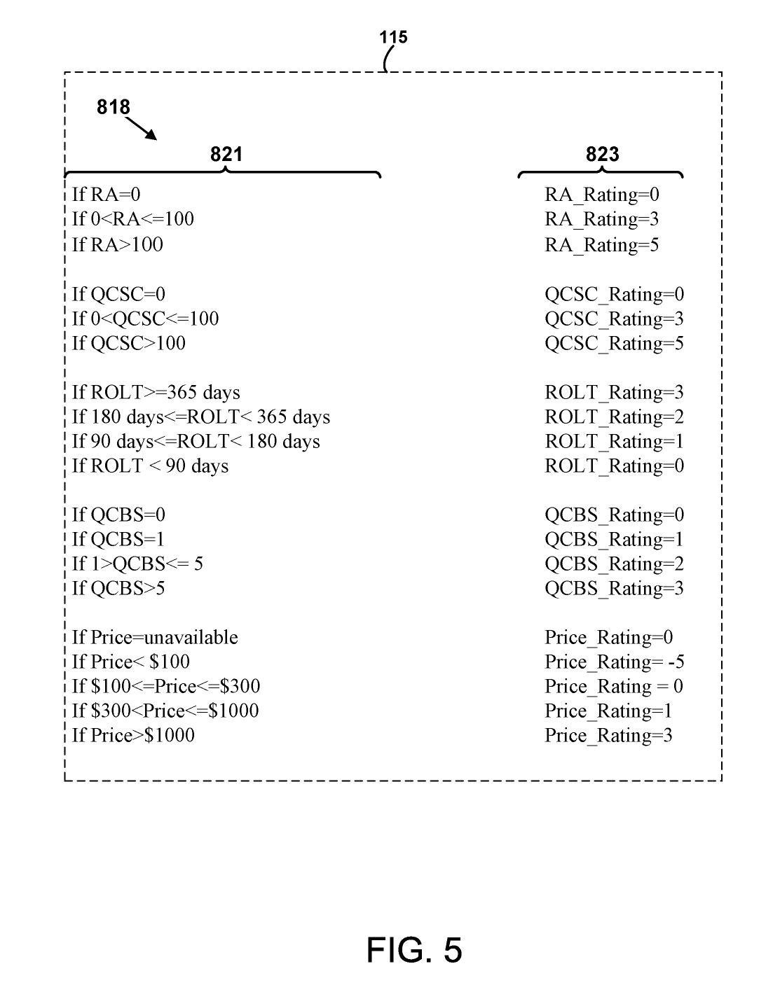

FIG. 5 shows additional data 115 arranged as a table. As shown in FIG. 5, the data 115 may also represent predefined relationships 818 between potential results 821 and numerical values 823. FIG. 5 is described in more detail below.

Referring to FIG. 2, the one or more non-transitory computer readable media 104 may also store ratings 119 that pertain to aircraft components. As shown, the ratings 119, the data 115, and other information are stored in the form a self-referential table. This format allows a user to easily update the structure of the table and/or how various analysis techniques are performed. For example, by adding a row (ID11) to the bottom of the table, a new column can easily be added to the table. This column can be used to store a rating 119 that pertains to whether repairing or replacing a component requires taking an aircraft out of service. The column #11 refers to the label of its field, “LRU_Rating.” This self-referential structure may allow for fast consideration of one or more factors to determine used component value, may allow the table to be updated quickly, and may allow the table to be more quickly searched. This allows the computing system 100 to make decisions about whether to begin or cease efforts to retrieve or curate a particular component based on the most recent information. FIG. 4 also shows data stored in the form of a self-referential table, yielding similar advantages. The format of these data structures help the computing system 100 access, search, and update the data 115 in a manner that allows the computing system 100 to take advantage of system flexibility and up-to-date information.

The communication interface 106 may include hardware to enable communication within the computing system 100 and/or between the computing system 100 and one or more other devices. The hardware may include transmitters, receivers, and antennas, for example. The communication interface 106 may be configured to facilitate communication with one or more other devices, in accordance with one or more wired or wireless communication protocols. For example, the communication interface 106 may be configured to facilitate wireless data communication for the computing system 100 according to one or more wireless communication standards, such as one or more IEEE 801.11 standards, ZigBee standards, Bluetooth standards, etc. As another example, the communication interface 106 may be configured to facilitate wired data communication with one or more other devices.

The display 108 may be any type of display component configured to display data. As one example, the display 108 may include a touchscreen display. As another example, the display 108 may include a flat-panel display, such as a liquid-crystal display (LCD) or a light-emitting diode (LED) display.

The user interface 110 may include one or more pieces of hardware used to provide data and control signals to the computing system 100. For instance, the user interface 110 may include a mouse or a pointing device, a keyboard or a keypad, a microphone, a touchpad, or a touchscreen, among other possible types of user interfaces. Generally, the user interface 110 may enable an operator to interact with a graphical user interface (GUI) provided by the computing system 100.

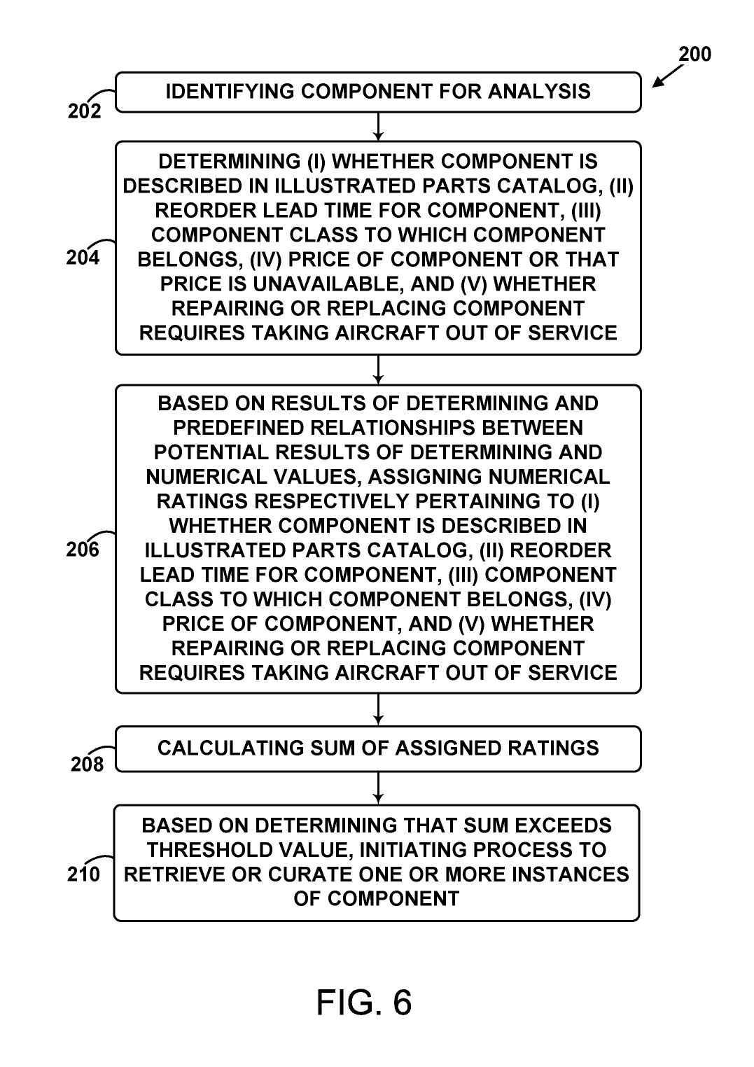

FIG. 6 depicts a method 200 for calculating a sum representing a value of an aircraft system component. The method 200 may be performed by the computing system 100, for example.

At block 202, the method 200 includes identifying the component for analysis. Referring to FIG. 2, for example, the computing system 100 may identify any of the components 304 labeled “x,” “y,” “z,” “a,” “b,” and “c” for analysis. The data 115 and additional data shown in FIG. 2 may be stored in the one or more non-transitory computer readable media 104.

In some examples, identifying the component for analysis may include selecting the component from a set of components based on the component having been least recently identified for analysis among the set of components. For example, the computing system 100 may identify the component 304 labeled “y” based on determining that the component 304 labeled “y” was least recently identified for analysis among the components 304.

At block 204, the method 200 includes determining (i) whether the component is described in the illustrated parts catalog, (ii) the reorder lead time for the component, (iii) the component class to which the component belongs, (iv) the price of the component or that the price is unavailable, and (v) whether repairing or replacing the component requires taking an aircraft out of service. In some examples, making the determinations (i)-(v) may involve accessing the data.

For instance, the computing system 100 may determine (i) whether the component 304 is described in the illustrated parts catalog, (ii) the reorder lead time for the component 304, (iii) the component class to which the component 304 belongs, (iv) the price of the component 304 or that the price is unavailable, and (v) whether repairing or replacing the component 304 requires taking an aircraft out of service. In some examples, making the determinations (i)-(v) may involve accessing the data 115.

For example, the computing system 100 may determine whether the component 304 labeled “y” is described in the illustrated parts catalog by accessing the data 115 at row 2 column “IPC.” Since this cell reads “Y,” the computing system 100 determines that the component 304 labeled “y” is described in the illustrated parts catalog.

In another example, the computing system 100 may determine whether the component 304 labeled “a” is described in the illustrated parts catalog by accessing the data 115 at row 4 column “IPC.” Since this cell reads “N,” the computing system 100 determines that the component 304 labeled “a” is not described in the illustrated parts catalog.

Referring to FIG. 3, the computing system 100 may determine whether the reorder lead time (ROLT) of the component 304 labeled “y” is greater than 365 days, greater than or equal to 180 days and less than 365 days, greater than or equal to 90 days and less than 180 days, or less than 90 days. The computing system 100 may do this by accessing the data 115 at row 2 column “ROLT.” Since this cell reads “182,” the computing system 100 determines that the ROLT for the component 304 labeled “y” is greater than or equal to 180 days and less than 365 days. Other threshold amounts of days may apply as well.

In another example, the computing system 100 may determine whether the reorder lead time (ROLT) of the component 304 labeled “x” is greater than 365 days, greater than or equal to 180 days and less than 365 days, greater than or equal to 90 days and less than 180 days, or less than 90 days. The computing system 100 may do this by accessing the data 115 at row 1 column “ROLT.” Since this cell reads “31,” the computing system 100 determines that the ROLT for the component 304 labeled “x” is less than 90 days. Other threshold amounts of days may apply as well.

Also, the computing system 100 may determine whether the component 304 labeled “y” (a) belongs to the component class (e.g., SPC) 2, (b) belongs to the component classes 6, 7, R, C, or F, (c) belongs to the component class 1, or (d) belongs to another component class. The computing system 100 may do this by accessing the data 115 at row 2 column “SPC.” Since this cell reads “1,” the computing system 100 determines that the component 304 labeled “y” belongs to the component class 1. Other component class designations may apply as well.

In another example, the computing system 100 may determine whether the component 304 labeled “x” (a) belongs to the component class (e.g., SPC) 2, (b) belongs to the component classes 6, 7, R, C, or F, (c) belongs to the component class 1, or (d) belongs to another component class. The computing system 100 may do this by accessing the data 115 at row 1 column “SPC.” Since this cell reads “2,” the computing system 100 determines that the component 304 labeled “x” belongs to the component class 2. Other component class designations may apply as well.

Additionally, the computing system 100 may determine whether the price of the component 304 labeled “y” is (a) unavailable, (b) less than $100, (c) greater than or equal to $100 and less than or equal to $300, (d) greater than $300 and less than or equal to $1000, or (e) greater than $1000. The computing system 100 may do this by accessing the data 115 at row 2 column “PRICE.” Since this cell reads “1200,” the computing system 100 determines that the price of the component 304 labeled “y” is greater than $1000. Other price thresholds may apply as well.

In another example, the computing system 100 may determine whether the price of the component 304 labeled “x” is (a) unavailable, (b) less than $100, (c) greater than or equal to $100 and less than or equal to $300, (d) greater than $300 and less than or equal to $1000, or (e) greater than $1000. The computing system 100 may do this by accessing the data 115 at row 1 column “PRICE.” Since this cell reads “U,” the computing system 100 determines that the price of the component 304 labeled “x” is unavailable. Other price thresholds may apply as well.

Furthermore, the computing system 100 may determine whether repairing or replacing the component 304 labeled “y” requires taking an aircraft out of service. The computing system 100 may do this by accessing the data 115 at row 2 column “LRU.” Since this cell reads “N,” the computing system 100 determines that repairing or replacing the component 304 labeled “y” requires taking an aircraft out of service. That is, the component 304 labeled “y” is not “line replaceable.”

In another example, the computing system 100 may determine whether repairing or replacing the component 304 labeled “x” requires taking an aircraft out of service. The computing system 100 may do this by accessing the data 115 at row 1 column “LRU.” Since this cell reads “Y,” the computing system 100 determines that repairing or replacing the component 304 labeled “x” does not require taking an aircraft out of service. That is, the component 304 labeled “x” is “line replaceable.”

Referring back to FIG. 6, at block 206, the method 200 includes, based on results of the determining and predefined relationships between potential results of the determining and numerical values, assigning numerical ratings respectively pertaining to (i) whether the component is described in the illustrated parts catalog, (ii) the reorder lead time for the component, (iii) the component class to which the component belongs, (iv) the price of the component, and (v) whether repairing or replacing the component requires taking an aircraft out of service.

Referring to FIG. 3, the computing system 100 may use the results of the determining of block 204 and predefined relationships 118 between potential results 121 of the determining of block 204 and numerical values 123 to assign numerical ratings 119 (see FIG. 2). The numerical ratings 119 may respectively pertain to (i) whether the component 304 is described in the illustrated parts catalog, (ii) the reorder lead time for the component 304, (iii) the component class to which the component 304 belongs, (iv) the price of the component 304, and (v) whether repairing or replacing the component 304 requires taking an aircraft out of service. Referring to FIG. 8, the method 200 may include accessing additional data 115 representing the predefined relationships 118. In this context, the numerical ratings 119 are assigned according to the predefined relationships 118 represented by the additional data 115.

Referring to FIG. 3 and previous examples, since the computing system 100 determined that the component 304 labeled “y” is described in the illustrated parts catalog, the computing system 100 assigns a numerical value 5 to the rating found at row 2 column #7, in accordance with the predefined relationships 118.

In another example, since the computing system 100 determined that the component 304 labeled “a” is not described in the illustrated parts catalog, the computing system 100 assigns a numerical value 0 to the rating found at row 4 column #7, in accordance with the predefined relationships 118.

Since the computing system 100 determined that the ROLT for component 304 labeled “y” is greater than or equal to 180 days and less than 365 days, the computing system 100 assigns a numerical value 2 to the rating found at row 2 column #8, in accordance with the predefined relationships 118.

Since the computing system 100 determined that the ROLT for component 304 labeled “x” is less than 90 days, the computing system 100 assigns a numerical value 0 to the rating found at row 1 column #8, in accordance with the predefined relationships 118.

Since the computing system 100 determined that the component 304 labeled “y” belongs to the component class 1, the computing system 100 assigns a numerical value 1 to the rating found at row 2 column #9, in accordance with the predefined relationships 118.

Since the computing system 100 determined that the component 304 labeled “x” belongs to the component class 2, the computing system 100 assigns a numerical value 3 to the rating found at row 1 column #9, in accordance with the predefined relationships 118.

Since the computing system 100 determined that the price of the component 304 labeled “y” is greater than $1000, the computing system 100 assigns a numerical value 3 to the rating found at row 2 column #10, in accordance with the predefined relationships 118.

Since the computing system 100 determined that the price of the component 304 labeled “x” is unavailable, the computing system 100 assigns a numerical value 0 to the rating found at row 1 column #10, in accordance with the predefined relationships 118.

Since the computing system 100 determined that repairing or replacing the component 304 labeled “y” requires taking an aircraft out of service (LRU=N), the computing system 100 assigns a numerical value 0 to the rating found at row 2 column #11, in accordance with the predefined relationships 118.

Since the computing system 100 determined that repairing or replacing the component 304 labeled “x” does not require taking an aircraft out of service (LRU=Y), the computing system 100 assigns a numerical value 5 to the rating found at row 1 column #11, in accordance with the predefined relationships 118.

Referring back to FIG. 6, at block 208, the method 200 includes calculating a sum of the assigned ratings. For example, the computing system 100 may calculate a sum 302 of the assigned ratings 119. Referring to FIG. 2, the sum 302 corresponding to the component 304 labeled “y” is found at row 2 column “sum” and is equal to 11 (5+2+1+3+0).

In another example, the sum 302 corresponding to the component 304 labeled “x” is found at row 1 column “sum” and is equal to 13 (5+0+3+0+5).

At block 210, the method 200 includes based on determining that the sum exceeds a threshold value, initiating a process to retrieve or curate one or more instances of the component. In some examples, the threshold value might be equal to 10, but other examples are possible. In this case, since the sum corresponding to the component 304 labeled “y” is 11 and is greater than 10, the computing system 100 may initiate a process to retrieve or curate one or more instances of the component 304 labeled “y.” This may involve the computing system 100 producing a task list directing a human salvager to find appropriate retired aircraft on the property and retrieve one or more instances of the component 304 labeled “y.”

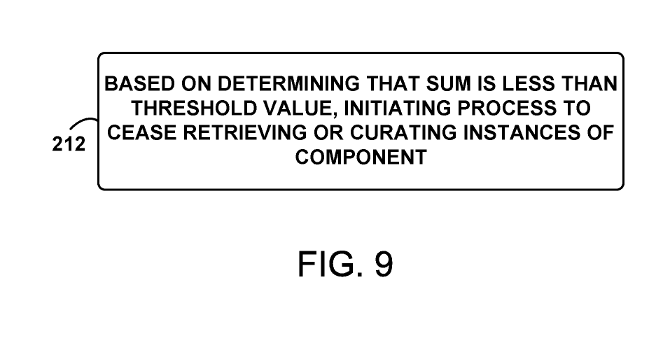

In other examples, the method 200 may include at block 212 as shown in FIG. 9, based on determining that the sum is less than a threshold value, initiating a process to cease retrieving or curating instances of the component. In this case, the threshold value may be equal to 12, but other examples are possible. In this case, since the sum corresponding to the component 304 labeled “y” is 11 and is less than 12, the computing system 100 may initiate a process to cease retrieving or curating one or more instances of the component 304 labeled “y.” This may involve the computing system 100 producing a task list directing a human salvager to stop searching for the component 304 labeled “y” and/or clear warehouse space currently housing the component 304 labeled “y” to free space for housing other more currently valuable components.

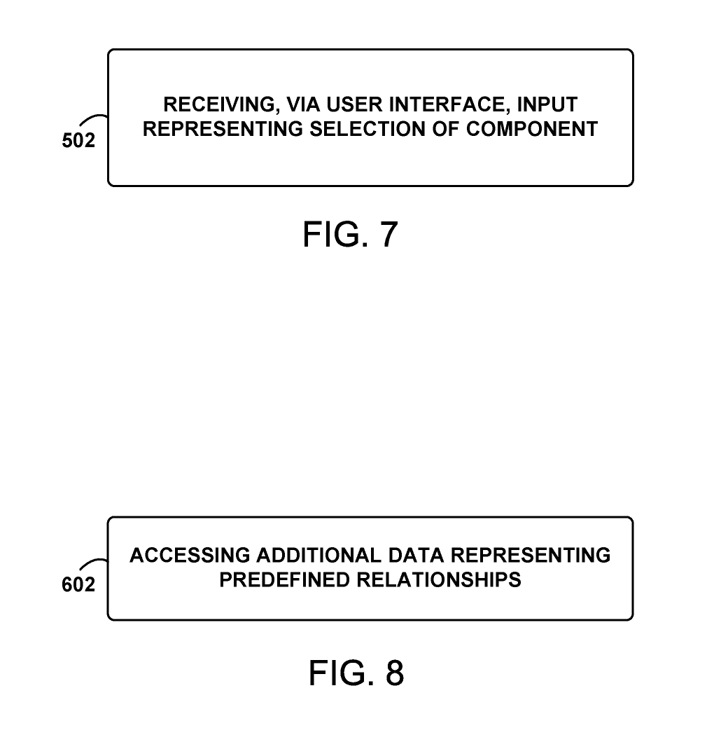

Referring to FIG. 7 for yet another example, the method 200 may further include at block 502 receiving, via a user interface, input representing a selection of the component. In this context, identifying the component for analysis may include identifying the component represented by the input received via the user interface. For example, the computing system 100 may receive, via the user interface 110, input representing a selection of the component 304 labeled “y.” In this context, identifying the component 304 for analysis may include identifying the component 304 represented by the input.

As noted above, one aspect of the disclosure above is the computing system 100 configured to perform functions of the method 200 for calculating a sum 302 representing a value of an aircraft system component 304. The computing system 100 includes one or more processors 102 and one or more non-transitory computer readable media 104 storing: data 115 pertaining to (i) whether the component 304 is described in an illustrated parts catalog, (ii) a reorder lead time for the component 304, (iii) a component class to which the component 304 belongs, where the component class pertains to how difficult the component 304 is to repair, (iv) a price of the component 304, and (v) whether repairing or replacing the component 304 requires taking an aircraft out of service. The one or more non-transitory computer readable media 104 also store instructions, that when executed by the one or more processors 102, cause the computing system 100 to perform functions. The functions include identifying the component 304 for analysis and determining (i) whether the component 304 is described in the illustrated parts catalog, (ii) the reorder lead time for the component 304, (iii) the component class to which the component 304 belongs, (iv) the price of the component 304 or that the price is unavailable, and (v) whether repairing or replacing the component 304 requires taking an aircraft out of service. The functions further include, based on results of the determining and predefined relationships 118 between potential results 121 of the determining and numerical values 123, assigning numerical ratings 119 respectively pertaining to (i) whether the component 304 is described in the illustrated parts catalog, (ii) the reorder lead time for the component 304, (iii) the component class to which the component 304 belongs, (iv) the price of the component 304, and (v) whether repairing or replacing the component 304 requires taking an aircraft out of service. The functions further include calculating a sum 302 of the assigned ratings 119 and, based on determining that the sum 302 exceeds a threshold value, initiating a process to retrieve or curate one or more instances of the component 304.

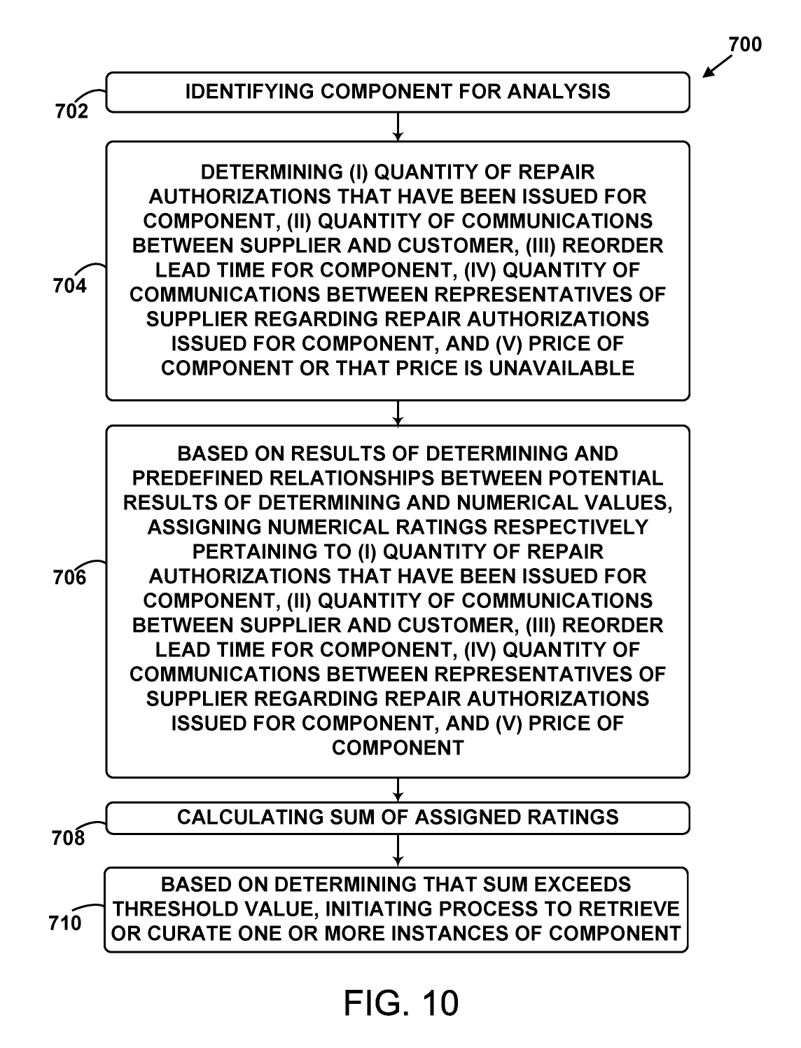

FIG. 10 depicts a method 700 for calculating a sum representing a value of an aircraft structural component. The method 700 may be performed by the computing system 100, for example.

At block 702, the method 700 includes identifying the component for analysis. Referring to FIG. 4, for example, the computing system 100 may identify any of the components 804 labeled “u,” “v,” “w,” “d,” “e,” and “f” for analysis. The data 115 and additional data shown in FIG. 4 may be stored in the one or more non-transitory computer readable media 104.

In some examples, identifying the component for analysis may include selecting the component from a set of components based on the component having been least recently identified for analysis among the set of components. For example, the computing system 100 may identify the component 804 labeled “u” based on determining that the component 804 labeled “u” was least recently identified for analysis among the components 804.

At block 704, the method 700 includes determining (i) the quantity of repair authorizations that have been issued for the component, (ii) the quantity of communications between the supplier and a customer, (iii) the reorder lead time for the component, (iv) the quantity of communications between representatives of the supplier regarding repair authorizations issued for the component, and (v) the price of the component or that the price is unavailable. In some examples, making the determinations (i)-(v) may involve accessing the data.

For instance, the computing system 100 may determine (i) the quantity of repair authorizations that have been issued for the component 804, (ii) the quantity of communications between the supplier and a customer, (iii) the reorder lead time for the component 804, (iv) the quantity of communications between representatives of the supplier regarding repair authorizations issued for the component 804, and (v) the price of the component 804 or that the price is unavailable. In some examples, making the determinations (i)-(v) may involve accessing the data 115.

Referring to FIGS. 4 and 5, the computing system 100 may determine whether the quantity of repair authorizations (RAs) that have been issued for the component 804 labeled “u” is equal to 0, greater than 0 and less than or equal to 100, or greater than 100. The computing system 100 may do this by accessing the data 115 at row 1 column “RA.” Since this cell reads “0,” the computing system 100 determines that the quantity of RAs issued for the component 804 labeled “u” is equal to 0. Other threshold values for RAs may apply as well.

In another example, the computing system 100 may determine whether the quantity of repair authorizations (RAs) that have been issued for the component 804 labeled “v” is equal to 0, greater than 0 and less than or equal to 100, or greater than 100. The computing system 100 may do this by accessing the data 115 at row 2 column “RA.” Since this cell reads “85,” the computing system 100 determines that the quantity of RAs issued for the component 804 labeled “u” is greater than 0 and less than or equal to 100. Other threshold values for RAs may apply as well.

The computing system 100 may also determine whether the quantity of communications between the supplier and a customer (QCSC) regarding repair authorizations for the component 804 labeled “u” is equal to 0, greater than 0 and less than or equal to 100, or greater than 100. The computing system 100 may do this by accessing the data 115 at row 1 column “QCSC.” Since this cell reads “0,” the computing system 100 determines that the QCSC for the component 804 labeled “u” is equal to 0. Other threshold values for QCSC may apply as well.

The computing system 100 may also determine whether the QCSC for the component 804 labeled “v” is equal to 0, greater than 0 and less than or equal to 100, or greater than 100. The computing system 100 may do this by accessing the data 115 at row 2 column “QCSC.” Since this cell reads “120,” the computing system 100 determines that the QCSC for the component 804 labeled “v” is greater than 100. Other threshold values for QCSC may apply as well.

The computing system 100 may determine whether the reorder lead time (ROLT) of the component 804 labeled “u” is greater than 365 days, greater than or equal to 180 days and less than 365 days, greater than or equal to 90 days and less than 180 days, or less than 90 days. The computing system 100 may do this by accessing the data 115 at row 1 column “ROLT.” Since this cell reads “29,” the computing system 100 determines that the ROLT for the component 804 labeled “u” is less than 90 days. Other threshold amounts of days may apply as well.

In another example, the computing system 100 may determine whether the reorder lead time (ROLT) of the component 804 labeled “v” is greater than 365 days, greater than or equal to 180 days and less than 365 days, greater than or equal to 90 days and less than 180 days, or less than 90 days. The computing system 100 may do this by accessing the data 115 at row 2 column “ROLT.” Since this cell reads “179,” the computing system 100 determines that the ROLT for the component 804 labeled “v” is greater than or equal to 90 days and less than 180 days. Other threshold amounts of days may apply as well.

The computing system 100 may determine whether the quantity of communications between representatives of the supplier regarding repair authorizations (QCBS) issued for the component 804 labeled “u” is equal to 0, equal to 1, greater than 1 and less than or equal to 5, or greater than 5. The computing system 100 may do this by accessing the data 115 at row 1 column “QCBS.” Since this cell reads “3,” the computing system 100 determines that the QCBS for the component 804 labeled “u” is greater than 1 and less than or equal to 5. Other threshold quantities of QCBS may apply as well.

In another example, the computing system 100 may determine whether the quantity of communications between representatives of the supplier regarding repair authorizations (QCBS) issued for the component 804 labeled “v” is equal to 0, equal to 1, greater than 1 and less than or equal to 5, or greater than 5. The computing system 100 may do this by accessing the data 115 at row 2 column “QCBS.” Since this cell reads “7,” the computing system 100 determines that the QCBS for the component 804 labeled “v” is greater than 5. Other threshold quantities of QCBS may apply as well.

Additionally, the computing system 100 may determine whether the price of the component 804 labeled “u” is (a) unavailable, (b) less than $100, (c) greater than or equal to $100 and less than or equal to $300, (d) greater than $300 and less than or equal to $1000, or (e) greater than $1000. The computing system 100 may do this by accessing the data 115 at row 1 column “PRICE.” Since this cell reads “U,” the computing system 100 determines that the price of the component 804 labeled “u” is unavailable. Other price thresholds may apply as well.

In another example, the computing system 100 may determine whether the price of the component 804 labeled “v” is (a) unavailable, (b) less than $100, (c) greater than or equal to $100 and less than or equal to $300, (d) greater than $300 and less than or equal to $1000, or (e) greater than $1000. The computing system 100 may do this by accessing the data 115 at row 2 column “PRICE.” Since this cell reads “1300,” the computing system 100 determines that the price of the component 804 labeled “v” is greater than $1000. Other price thresholds may apply as well.

At block 706, the method 700 includes, based on results of the determining and predefined relationships between potential results of the determining and numerical values, assigning numerical ratings respectively pertaining to (i) the quantity of repair authorizations that have been issued for the component, (ii) the quantity of communications between the supplier and a customer, (iii) the reorder lead time for the component, (iv) the quantity of communications between representatives of the supplier regarding repair authorizations issued for the component, and (v) the price of the component.

Referring to FIGS. 4 and 5, the computing system 100 may use the results of the determining of block 704 and predefined relationships 818 between potential results 821 of the determining of block 704 and numerical values 823 to assign numerical ratings 819. The numerical ratings 819 may respectively pertain to (i) the quantity of repair authorizations that have been issued for the component 804, (ii) the quantity of communications between the supplier and a customer, (iii) the reorder lead time for the component 804, (iv) the quantity of communications between representatives of the supplier regarding repair authorizations issued for the component 804, and (v) the price of the component 804. Referring to FIG. 8, the method 700 may further include at block 602 accessing additional data 115 representing the predefined relationships 818. In this context, the numerical ratings 819 are assigned according to the predefined relationships 818 represented by the additional data 115.

Referring to FIGS. 4 and 5 and previous examples, since the computing system 100 determined that the quantity of repair authorizations (RAs) issued for the component 804 labeled “u” is equal to 0, the computing system 100 assigns a numerical value 0 to the rating 819 found at row 1 column #7, in accordance with the predefined relationships 818.

In another example, since the computing system 100 determined that the quantity of repair authorizations (RAs) issued for the component 804 labeled “v” is greater than 0 and less than or equal to 100, the computing system 100 assigns a numerical value 3 to the rating 819 found at row 2 column #7, in accordance with the predefined relationships 818.

Since the computing system 100 determined that quantity of communications between the supplier and a customer (QCSC) regarding repair authorizations for the component 804 labeled “u” is equal to 0, the computing system 100 assigns a numerical value 0 to the rating 819 found at row 1 column #8, in accordance with the predefined relationships 818.

In another example, since the computing system 100 determined that quantity of communications between the supplier and a customer (QCSC) regarding repair authorizations for the component 804 labeled “v” is greater than 100, the computing system 100 assigns a numerical value 5 to the rating 819 found at row 2 column #8, in accordance with the predefined relationships 818.

Since the computing system 100 determined that the ROLT for component 804 labeled “u” is less than 90 days, the computing system 100 assigns a numerical value 0 to the rating found at row 2 column #9, in accordance with the predefined relationships 818.

Since the computing system 100 determined that the ROLT for component 804 labeled “v” is greater than or equal to 90 days and less than 180 days, the computing system 100 assigns a numerical value 1 to the rating found at row 2 column #9, in accordance with the predefined relationships 818.

Since the computing system 100 determined that the quantity of communications between representatives of the supplier regarding repair authorizations (QCBS) issued for the component 804 labeled “u” is greater than 1 and less than or equal to 5, the computing system 100 assigns a numerical value 2 to the rating found at row 1 column #10, in accordance with the predefined relationships 818.

Since the computing system 100 determined that the quantity of communications between representatives of the supplier regarding repair authorizations (QCBS) issued for the component 804 labeled “v” is greater than 5, the computing system 100 assigns a numerical value 3 to the rating found at row 2 column #10, in accordance with the predefined relationships 818.

Since the computing system 100 determined that the price of the component 804 labeled “u” is unavailable, the computing system 100 assigns a numerical value 0 to the rating found at row 1 column #11, in accordance with the predefined relationships 818.

Since the computing system 100 determined that the price of the component 804 labeled “v” is greater than $1000, the computing system 100 assigns a numerical value 3 to the rating found at row 2 column #11, in accordance with the predefined relationships 818.

At block 708, the method 700 includes calculating a sum of the assigned ratings. For example, the computing system 100 may calculate a sum 802 of the assigned ratings 819. Referring to FIG. 4, the sum 802 corresponding to the component 804 labeled “u” is found at row 1 column “sum” and is equal to 2 (0+0+0+2+0). In another example, the sum 802 corresponding to the component 804 labeled “v” is found at row 2 column “sum” and is equal to 15 (3+5+1+3+3).

At block 710, the method 700 includes based on determining that the sum exceeds a threshold value, initiating a process to retrieve or curate one or more instances of the component. In some examples, the threshold value might be equal to 10, but other examples are possible. In this case, since the sum corresponding to the component 804 labeled “v” is 15 and is greater than 10, the computing system 100 may initiate a process to retrieve or curate one or more instances of the component 804 labeled “v.” This may involve the computing system 100 producing a task list directing a human salvager to find appropriate retired aircraft on the property and retrieve one or more instances of the component 804 labeled “v.”

In other examples, the method 700 may include at block 212 as shown in FIG. 9, based on determining that the sum is less than a threshold value, initiating a process to cease retrieving or curating instances of the component. In this case, the threshold value may be equal to 10, but other examples are possible. In this case, since the sum corresponding to the component 804 labeled “u” is 2 and is less than 10, the computing system 100 may initiate a process to cease retrieving or curating one or more instances of the component 804 labeled “u.” This may involve the computing system 100 producing a task list directing a human salvager to stop searching for the component 804 labeled “u” and/or clear warehouse space currently housing the component 804 labeled “u” to free space for housing other more currently valuable components.

Referring to FIG. 7 for yet another example, the method 700 may further include at block 502 receiving, via a user interface, input representing a selection of the component. In this context, identifying the component for analysis may include identifying the component represented by the input received via the user interface. For example, the computing system 100 may receive, via the user interface 110, input representing a selection of the component 804 labeled “u.” In this context, identifying the component 804 for analysis may include identifying the component 804 represented by the input.

As noted above, one aspect of the disclosure is the computing system 100 configured to perform functions for calculating a sum 802 representing a value of an aircraft structural component 804. The computing system 100 includes one or more processors 102 and one or more non-transitory computer readable media 104 that store: data pertaining to (i) a quantity of repair authorizations that have been issued for a component 804, (ii) a quantity of communications between a supplier and a customer, wherein the communications regard repair authorizations issued for the component 804, (iii) a reorder lead time for the component 804, (iv) a quantity of communications between representatives of the supplier regarding repair authorizations issued for the component 804, and (v) a price of the component 804. The one or more non-transitory computer readable media 104 also store instructions, that when executed by the one or more processors 102, cause the computing system 100 to perform functions. The functions include identifying the component 804 for analysis and determining (i) the quantity of repair authorizations that have been issued for the component 804, (ii) the quantity of communications between the supplier and a customer, (iii) the reorder lead time for the component 804, (iv) the quantity of communications between representatives of the supplier regarding repair authorizations issued for the component 804, and (v) the price of the component 804 or that the price is unavailable. The functions further include, based on results of the determining and predefined relationships 818 between potential results 821 of the determining and numerical values 823, assigning numerical ratings 819 respectively pertaining to (i) the quantity of repair authorizations that have been issued for the component 804, (ii) the quantity of communications between the supplier and a customer, (iii) the reorder lead time for the component 804, (iv) the quantity of communications between representatives of the supplier regarding repair authorizations issued for the component 804, and (v) the price of the component 804. The functions further include calculating a sum 802 of the assigned ratings 819 and, based on determining that the sum 802 exceeds a threshold value, initiating a process to retrieve or curate one or more instances of the component 804.

Embodiments of the present disclosure can thus relate to one of the enumerated example embodiment (EEEs) listed below.

EEE 1 is a computing system configured to perform functions for calculating a sum representing a value of an aircraft system component, the computing system comprising: one or more processors; and one or more non-transitory computer readable media storing: data pertaining to (i) whether a component is described in an illustrated parts catalog, (ii) a reorder lead time for the component, (iii) a component class to which the component belongs, wherein the component class pertains to how difficult the component is to repair, (iv) a price of the component, and (v) whether repairing or replacing the component requires taking an aircraft out of service; and instructions, that when executed by the one or more processors, cause the computing system to perform functions comprising: identifying the component for analysis; determining (i) whether the component is described in the illustrated parts catalog, (ii) the reorder lead time for the component, (iii) the component class to which the component belongs, (iv) the price of the component or that the price is unavailable, and (v) whether repairing or replacing the component requires taking an aircraft out of service; based on results of the determining and predefined relationships between potential results of the determining and numerical values, assigning numerical ratings respectively pertaining to (i) whether the component is described in the illustrated parts catalog, (ii) the reorder lead time for the component, (iii) the component class to which the component belongs, (iv) the price of the component, and (v) whether repairing or replacing the component requires taking an aircraft out of service; calculating a sum of the assigned ratings; and based on determining that the sum exceeds a threshold value, initiating a process to retrieve or curate one or more instances of the component.

EEE 2 is the computing system of EEE 1, wherein identifying the component for analysis comprises selecting the component from a set of components based on the component having been least recently identified for analysis among the set of components.

EEE 3 is the computing system of EEE 1, the functions further comprising: receiving, via a user interface, input representing a selection of the component, wherein identifying the component for analysis comprises identifying the component represented by the input.

EEE 4 is the computing system of any of EEEs 1-3, wherein determining (i) whether the component is described in the illustrated parts catalog, (ii) the reorder lead time for the component, (iii) the component class to which the component belongs, (iv) the price of the component or that the price is unavailable, and (v) whether repairing or replacing the component requires taking an aircraft out of service comprises accessing the data.

EEE 5 is the computing system of any of EEEs 1-4, the functions further comprising: accessing additional data representing the predefined relationships, wherein assigning the numerical ratings comprises assigning the numerical ratings according to the predefined relationships represented by the additional data.

EEE 6 is the computing system of any of EEEs 1-5, wherein determining the reorder lead time for the component comprises using the data to determine that the reorder lead time is greater than 0 days and less than a first threshold amount of days, greater than or equal to the first threshold amount of days and less than a second threshold amount of days, greater than or equal to the second threshold amount of days and less than a third threshold amount of days, or greater than or equal to the third threshold amount of days, and wherein assigning the numerical rating pertaining to the reorder lead time for the component comprises assigning the numerical rating based on the determined reorder lead time.

EEE 7 is the computing system of any EEEs 1-6, wherein determining the price of the component or that the price is unavailable comprises using the data to determine that the price of the component is unavailable, less than 100 U.S. Dollars (USD), greater than or equal to 100 USD and less than 300 USD, greater than or equal to 300 USD and less than 1000 USD, or greater than or equal to 1000 USD, and wherein assigning the numerical rating pertaining to the price of the component comprises assigning the numerical rating based on the determined price of the component or that the price is unavailable.

EEE 8 is a computing system configured to perform functions for calculating a sum representing a value of an aircraft structural component, the computing system comprising: one or more processors; and one or more non-transitory computer readable media storing: data pertaining to (i) a quantity of repair authorizations that have been issued for a component, (ii) a quantity of communications between a supplier and a customer, wherein the communications regard repair authorizations issued for the component, (iii) a reorder lead time for the component, (iv) a quantity of communications between representatives of the supplier regarding repair authorizations issued for the component, and (v) a price of the component; and instructions, that when executed by the one or more processors, cause the computing system to perform functions comprising: identifying the component for analysis; determining (i) the quantity of repair authorizations that have been issued for the component, (ii) the quantity of communications between the supplier and a customer, (iii) the reorder lead time for the component, (iv) the quantity of communications between representatives of the supplier regarding repair authorizations issued for the component, and (v) the price of the component or that the price is unavailable; based on results of the determining and predefined relationships between potential results of the determining and numerical values, assigning numerical ratings respectively pertaining to (i) the quantity of repair authorizations that have been issued for the component, (ii) the quantity of communications between the supplier and a customer, (iii) the reorder lead time for the component, (iv) the quantity of communications between representatives of the supplier regarding repair authorizations issued for the component, and (v) the price of the component; calculating a sum of the assigned ratings; and based on determining that the sum exceeds a threshold value, initiating a process to retrieve or curate one or more instances of the component.

EEE 9 is the computing system of EEE 8, wherein identifying the component for analysis comprises selecting the component from a set of components based on the component having been least recently identified for analysis among the set of components.

EEE 10 is the computing system of EEE 8, the functions further comprising: receiving, via a user interface, input representing a selection of the component, wherein identifying the component for analysis comprises identifying the component represented by the input.

EEE 11 is the computing system of any of EEEs 8-10, wherein determining (i) the quantity of repair authorizations that have been issued for the component, (ii) the quantity of communications between the supplier and a customer, (iii) the reorder lead time for the component, (iv) the quantity of communications between representatives of the supplier regarding repair authorizations issued for the component, and (v) the price of the component or that the price is unavailable comprises accessing the data.

EEE 12 is the computing system of any of EEEs 8-11, the functions further comprising: accessing additional data representing the predefined relationships, wherein assigning the numerical ratings comprises assigning the numerical ratings according to the predefined relationships represented by the additional data.

EEE 13 is the computing system of any of EEEs 8-12, wherein determining the quantity of repair authorizations that have been issued for the component comprises using the data to determine that the quantity of repair authorizations is 0, greater than 0 and less than or equal to 100, or greater than 100, and wherein assigning the numerical rating pertaining to the quantity of repair authorizations comprises assigning the numerical rating based on the determined quantity of repair authorizations.

EEE 14 is the computing system of any of EEEs 8-13, wherein determining the quantity of communications between the supplier and a customer comprises using the data to determine that the quantity of communications between the supplier and a customer is 0, greater than 0 and less than or equal to 100, or greater than 100, and wherein assigning the numerical rating pertaining to the quantity of communications between the supplier and a customer comprises assigning the numerical rating based on the determined quantity of communications between the supplier and a customer.

EEE 15 is the computing system of any of EEEs 8-14, wherein determining the reorder lead time for the component comprises using the data to determine that the reorder lead time is less than 90 days, greater than or equal to 90 days and less than 180 days, greater than or equal to 180 days and less than 365 days, or greater than or equal to 365 days, and wherein assigning the numerical rating pertaining to the reorder lead time comprises assigning the numerical rating based on the determined reorder lead time.

EEE 16 is the computing system of any of EEEs 8-15, wherein determining the quantity of communications between representatives of the supplier regarding repair authorizations issued for the component comprises using the data to determine that the quantity of communications between representatives of the supplier is 0, 1, greater than 1 and less than or equal to 5, or greater than 5, and wherein assigning the numerical rating pertaining to the quantity of communications between representatives of the supplier comprises assigning the numerical rating based on the determined quantity of communications between representatives of the supplier.

EEE 17 is the computing system of any of EEEs 8-16, wherein determining the price of the component or that the price is unavailable comprises using the data to determine that the price of the component is unavailable, less than 100 U.S. Dollars (USD), greater than or equal to 100 USD and less than 300 USD, greater than or equal to 300 USD and less than 1000 USD, or greater than or equal to 1000 USD, and wherein assigning the numerical rating pertaining to the price of the component comprises assigning the numerical rating based on the determined price of the component or that the price is unavailable.

EEE 18 is a computing system configured to perform functions for calculating a sum representing a value of an aircraft system component, the computing system comprising: one or more processors; and one or more non-transitory computer readable media storing: data pertaining to (i) whether a component is described in an illustrated parts catalog, (ii) a reorder lead time for the component, (iii) a component class to which the component belongs, wherein the component class pertains to how difficult the component is to repair, (iv) a price of the component, and (v) whether repairing or replacing the component requires taking an aircraft out of service; and instructions, that when executed by the one or more processors, cause the computing system to perform functions comprising: identifying the component for analysis; determining (i) whether the component is described in the illustrated parts catalog, (ii) the reorder lead time for the component, (iii) the component class to which the component belongs, (iv) the price of the component or that the price is unavailable, and (v) whether repairing or replacing the component requires taking an aircraft out of service; based on results of the determining and predefined relationships between potential results of the determining and numerical values, assigning numerical ratings respectively pertaining to (i) whether the component is described in the illustrated parts catalog, (ii) the reorder lead time for the component, (iii) the component class to which the component belongs, (iv) the price of the component, and (v) whether repairing or replacing the component requires taking an aircraft out of service; calculating a sum of the assigned ratings; and based on determining that the sum is less than a threshold value, initiating a process to cease retrieving or curating instances of the component.

EEE 19 is the computing system of EEE 18, wherein determining (i) whether the component is described in the illustrated parts catalog, (ii) the reorder lead time for the component, (iii) the component class to which the component belongs, (iv) the price of the component or that the price is unavailable, and (v) whether repairing or replacing the component requires taking an aircraft out of service comprises accessing the data.

EEE 20 is the computing system of any of EEEs 18-19, the functions further comprising: accessing additional data representing the predefined relationships, wherein assigning the numerical ratings comprises assigning the numerical ratings according to the predefined relationships represented by the additional data.

The description of the different advantageous arrangements has been presented for purposes of illustration and description, and is not intended to be exhaustive or limited to the embodiments in the form disclosed. Many modifications and variations will be apparent to those of ordinary skill in the art. Further, different advantageous embodiments may describe different advantages as compared to other advantageous embodiments. The embodiment or embodiments selected are chosen and described in order to explain the principles of the embodiments, the practical application, and to enable others of ordinary skill in the art to understand the disclosure for various embodiments with various modifications as are suited to the particular use contemplated.

What is claimed is:

1. A computing system configured to perform functions for calculating a sum representing a value of an aircraft system component, the computing system comprising:
one or more processors; and
one or more non-transitory computer readable media storing:
data pertaining to (i) whether a component is described in an illustrated parts catalog, (ii) a reorder lead time for the component, (iii) a component class to which the component belongs, wherein the component class pertains to how difficult the component is to repair, (iv) a price of the component, and (v) whether repairing or replacing the component requires taking an aircraft out of service; and
instructions, that when executed by the one or more processors, cause the computing system to perform functions comprising:
identifying the component for analysis;
determining (i) whether the component is described in the illustrated parts catalog, (ii) the reorder lead time for the component, (iii) the component class to which the component belongs, (iv) the price of the component or that the price is unavailable, and (v) whether repairing or replacing the component requires taking an aircraft out of service;
based on results of the determining and predefined relationships between potential results of the determining and numerical values, assigning numerical ratings respectively pertaining to (i) whether the component is described in the illustrated parts catalog, (ii) the reorder lead time for the component, (iii) the component class to which the component belongs, (iv) the price of the component, and (v) whether repairing or replacing the component requires taking an aircraft out of service;
calculating a sum of the assigned ratings; and
based on determining that the sum exceeds a threshold value, initiating a process to retrieve or curate one or more instances of the component.

2. The computing system of claim 1, wherein identifying the component for analysis comprises selecting the component from a set of components based on the component having been least recently identified for analysis among the set of components.

3. The computing system of claim 1, the functions further comprising:
receiving, via a user interface, input representing a selection of the component,
wherein identifying the component for analysis comprises identifying the component represented by the input.

4. The computing system of claim 1, wherein determining (i) whether the component is described in the illustrated parts catalog, (ii) the reorder lead time for the component, (iii) the component class to which the component belongs, (iv) the price of the component or that the price is unavailable, and (v) whether repairing or replacing the component requires taking an aircraft out of service comprises accessing the data.

5. The computing system of claim 1, the functions further comprising:
accessing additional data representing the predefined relationships,
wherein assigning the numerical ratings comprises assigning the numerical ratings according to the predefined relationships represented by the additional data.

6. The computing system of claim 1,
wherein determining the reorder lead time for the component comprises using the data to determine that the reorder lead time is greater than 0 days and less than a first threshold amount of days, greater than or equal to the first threshold amount of days and less than a second threshold amount of days, greater than or equal to the second threshold amount of days and less than a third threshold amount of days, or greater than or equal to the third threshold amount of days, and
wherein assigning the numerical rating pertaining to the reorder lead time for the component comprises assigning the numerical rating based on the determined reorder lead time.

7. The computing system of claim 1,
wherein determining the price of the component or that the price is unavailable comprises using the data to determine that the price of the component is unavailable, less than 100 U.S. Dollars (USD), greater than or equal to 100 USD and less than 300 USD, greater than or equal to 300 USD and less than 1000 USD, or greater than or equal to 1000 USD, and
wherein assigning the numerical rating pertaining to the price of the component comprises assigning the numerical rating based on the determined price of the component or that the price is unavailable.

8. A computing system configured to perform functions for calculating a sum representing a value of an aircraft structural component, the computing system comprising:
one or more processors; and
one or more non-transitory computer readable media storing:
data pertaining to (i) a quantity of repair authorizations that have been issued for a component, (ii) a quantity of communications between a supplier and a customer, wherein the communications regard repair authorizations issued for the component, (iii) a reorder lead time for the component, (iv) a quantity of communications between representatives of the supplier regarding repair authorizations issued for the component, and (v) a price of the component; and
instructions, that when executed by the one or more processors, cause the computing system to perform functions comprising:
identifying the component for analysis;
determining (i) the quantity of repair authorizations that have been issued for the component, (ii) the quantity of communications between the supplier and a customer, (iii) the reorder lead time for the component, (iv) the quantity of communications between representatives of the supplier regarding repair authorizations issued for the component, and (v) the price of the component or that the price is unavailable;
based on results of the determining and predefined relationships between potential results of the determining and numerical values, assigning numerical ratings respectively pertaining to (i) the quantity of repair authorizations that have been issued for the component, (ii) the quantity of communications between the supplier and a customer, (iii) the reorder lead time for the component, (iv) the quantity of communications between representatives of the supplier regarding repair authorizations issued for the component, and (v) the price of the component;
calculating a sum of the assigned ratings; and
based on determining that the sum exceeds a threshold value, initiating a process to retrieve or curate one or more instances of the component.

9. The computing system of claim 8, wherein identifying the component for analysis comprises selecting the component from a set of components based on the component having been least recently identified for analysis among the set of components.

10. The computing system of claim 8, the functions further comprising:
receiving, via a user interface, input representing a selection of the component,
wherein identifying the component for analysis comprises identifying the component represented by the input.

11. The computing system of claim 8, wherein determining (i) the quantity of repair authorizations that have been issued for the component, (ii) the quantity of communications between the supplier and a customer, (iii) the reorder lead time for the component, (iv) the quantity of communications between representatives of the supplier regarding repair authorizations issued for the component, and (v) the price of the component or that the price is unavailable comprises accessing the data.

12. The computing system of claim 8, the functions further comprising:
accessing additional data representing the predefined relationships,
wherein assigning the numerical ratings comprises assigning the numerical ratings according to the predefined relationships represented by the additional data.

13. The computing system of claim 8,
wherein determining the quantity of repair authorizations that have been issued for the component comprises using the data to determine that the quantity of repair authorizations is 0, greater than 0 and less than or equal to 100, or greater than 100, and
wherein assigning the numerical rating pertaining to the quantity of repair authorizations comprises assigning the numerical rating based on the determined quantity of repair authorizations.

14. The computing system of claim 8,
wherein determining the quantity of communications between the supplier and a customer comprises using the data to determine that the quantity of communications between the supplier and a customer is 0, greater than 0 and less than or equal to 100, or greater than 100, and
wherein assigning the numerical rating pertaining to the quantity of communications between the supplier and a customer comprises assigning the numerical rating based on the determined quantity of communications between the supplier and a customer.

15. The computing system of claim 8,
wherein determining the reorder lead time for the component comprises using the data to determine that the reorder lead time is less than 90 days, greater than or equal to 90 days and less than 180 days, greater than or equal to 180 days and less than 365 days, or greater than or equal to 365 days, and
wherein assigning the numerical rating pertaining to the reorder lead time comprises assigning the numerical rating based on the determined reorder lead time.

16. The computing system of claim 8,
wherein determining the quantity of communications between representatives of the supplier regarding repair authorizations issued for the component comprises using the data to determine that the quantity of communications between representatives of the supplier is 0, 1, greater than 1 and less than or equal to 5, or greater than 5, and
wherein assigning the numerical rating pertaining to the quantity of communications between representatives of the supplier comprises assigning the numerical rating based on the determined quantity of communications between representatives of the supplier.

17. The computing system of claim 8,
wherein determining the price of the component or that the price is unavailable comprises using the data to determine that the price of the component is unavailable, less than 100 U.S. Dollars (USD), greater than or equal to 100 USD and less than 300 USD, greater than or equal to 300 USD and less than 1000 USD, or greater than or equal to 1000 USD, and
wherein assigning the numerical rating pertaining to the price of the component comprises assigning the numerical rating based on the determined price of the component or that the price is unavailable.

18. A computing system configured to perform functions for calculating a sum representing a value of an aircraft system component, the computing system comprising:
one or more processors; and
one or more non-transitory computer readable media storing:
data pertaining to (i) whether a component is described in an illustrated parts catalog, (ii) a reorder lead time for the component, (iii) a component class to which the component belongs, wherein the component class pertains to how difficult the component is to repair, (iv) a price of the component, and (v) whether repairing or replacing the component requires taking an aircraft out of service; and
instructions, that when executed by the one or more processors, cause the computing system to perform functions comprising:
identifying the component for analysis;
determining (i) whether the component is described in the illustrated parts catalog, (ii) the reorder lead time for the component, (iii) the component class to which the component belongs, (iv) the price of the component or that the price is unavailable, and (v) whether repairing or replacing the component requires taking an aircraft out of service;
based on results of the determining and predefined relationships between potential results of the determining and numerical values, assigning numerical ratings respectively pertaining to (i) whether the component is described in the illustrated parts catalog, (ii) the reorder lead time for the component, (iii) the component class to which the component belongs, (iv) the price of the component, and (v) whether repairing or replacing the component requires taking an aircraft out of service;
calculating a sum of the assigned ratings; and
based on determining that the sum is less than a threshold value, initiating a process to cease retrieving or curating instances of the component.

19. The computing system of claim 18, wherein determining (i) whether the component is described in the illustrated parts catalog, (ii) the reorder lead time for the component, (iii) the component class to which the component belongs, (iv) the price of the component or that the price is unavailable, and (v) whether repairing or replacing the component requires taking an aircraft out of service comprises accessing the data.

20. The computing system of claim 18, the functions further comprising:
accessing additional data representing the predefined relationships,
wherein assigning the numerical ratings comprises assigning the numerical ratings according to the predefined relationships represented by the additional data.
